(19) United States
(12) Patent Application Publication
(10) Pub. No.: US 2016/0169166 A1
(43) Pub. Date: Jun. 16, 2016

(54) STRUCTURE OF ENGINE SYSTEM

(71) Applicant: Hyundai Motor Company, Seoul (KR)

(72) Inventor: Won Rok CHOI, Seoul (KR)

(73) Assignee: Hyundai Motor Company, Seoul (KR)

(21) Appl. No.: 14/724,464

(22) Filed: May 28, 2015

(30) Foreign Application Priority Data
Dec. 10, 2014 (KR) 10-2014-0177806

(51) Int. Cl. F02M 26/32

(52) U.S. Cl. CPC F02M 26/32

(57) ABSTRACT

A structure of an engine system may include a cylinder head on a top of an engine to form combustion chambers together with a plurality of engine cylinders, an intake manifold having a plurality of runners connected to a plurality of intake ports formed in the cylinder head so as to be in fluid communication with the plurality of engine cylinders through the plurality of intake ports and the plurality of runners, and a water cooling intercooler having an outlet connected to an inlet to the intake manifold for cooling at least one of Exhaust Gas Recirculation (EGR) gas and new air with cooling water.

### CROSS-REFERENCE TO RELATED APPLICATION

The present application claims priority to and the benefit of Korean Patent Application No. 10-2014-0177806 filed in Dec. 10, 2014, the entire contents of which is incorporated herein for all purposes by this reference.

### BACKGROUND OF THE INVENTION

1. Field of the Invention

The present invention relates to a structure of an engine system. More particularly, the present invention relates to a structure of an engine system for improving Exhaust Gas Recirculation (EGR) distribution, assembly, and uniformity of an intake gas flow.

2. Description of Related Art

In general, a diesel engine is additionally provided with a supercharger and an intercooler for obtaining a greater output from the engine.

The diesel engine having the supercharger applied thereto has exhaust gas or external air compressed with a compressor of the supercharger for supplying the exhaust gas or new air compressed thusly to the engine.

However, the new air compressed rapidly absorbs heat from the supercharger and heat generated in a process of the compression to have low density, resulting in poor charging efficiency.

Therefore, by cooling the new air, i.e., supercharged air, with the intercooler, high density of the supercharged air can be obtained, such that more air can be drawn into the engine cylinder, enabling greater output.

Along with this, the diesel engine is provided with an exhaust gas recirculation (EGR) system mounted thereto for reducing exhaust of nitrogen oxide (NOx) which is one of air pollution materials.

Since the nitrogen oxide is a noxious gas produced as oxygen and nitrogen coupled at a high pressure and a high temperature, in order to suppress this, the exhaust gas recirculation (hereinafter, EGR) system supplies a portion of the exhaust gas being exhausted to the atmosphere to an intake system for dropping a highest combustion temperature and reducing oxygen supply for reducing production of the nitrogen oxide.

Since the EGR system is required to re-circulate the high temperature exhaust gas, the EGR system may be provided with an EGR cooler for cooling the exhaust gas. In the EGR coolers, there are a high pressure EGR cooler (HP-EGR cooler) connected to an exhaust manifold side EGR valve for cooling high pressure EGR gas directly flowing toward an intake manifold side, and a low pressure EGR cooler (LP-EGR cooler) for cooling low pressure EGR gas of which pressure is dropped as the exhaust gas passes through a turbine of the supercharger and a catalytic converter in succession.

Recently, a water cooling type of intercooler of which an intake gas route is made short for improving cooling efficiency and responsiveness has been applied to the EGR system. In this case, since the intake manifold is constructed as one unit with the water cooling type of intercooler as a box type having no surge tank or runner, flows among the cylinders may not be uniform.

Moreover, since the water cooling type of intercooler has a very small space for mixing the EGR gases and the new air, requiring a very short time period of mixing, EGR distribution is not favorable. In this case, the EGR distribution is a characteristic in which the high pressure EGR gas, the low pressure EGR gas, and the new air may be uniformly supplied to each of the cylinders of the engine while being appropriately mixed.

FIG. 1 illustrates a perspective view of a related art structure of an engine system having a water cooling type of intercooler applied thereto.

Referring to FIG. 1, a length of an assembly tool is required to be excessive due to an assembled structure of an intake manifold, a core of the water cooling type of intercooler, and an inlet tank of the water cooling type of intercooler. The excessive length of an assembly tool makes assembling of the engine system poor. Along with this, a poor bolt fastening torque causes frequent maintenance problems.

FIG. 2 illustrates a top plan view of a related art structure of an engine system having a water cooling type of intercooler applied thereto.

Referring to FIG. 2, new air, low pressure EGR gas, or a mixed gas of the new air and the low pressure EGR gas which is cooled while passing through the core of the water cooling type of intercooler may meet with high pressure EGR gas and may be introduced to the intake manifold. In this case, since a mixing distance of at least one of the new air and the low pressure EGR gas and the high pressure EGR gas is short, the EGR distribution becomes poor.

The above information disclosed in this Background section is only for enhancement of understanding of the background of the invention and therefore it may contain information that does not form the prior art that is already known in this country to a person of ordinary skill in the art.

### BRIEF SUMMARY

Various aspects of the present invention are directed to providing a structure of an engine system having advantages of improving EGR distribution, assembly, and uniformity of an intake gas flow.

Various aspects of the present invention are directed to providing a structure of an engine system for improving different problems of a related art structure of an engine system having a water cooling type of intercooler integrated with an intake manifold applied thereto.

According to various aspects of the present invention, a structure of an engine system may be provided, including a cylinder head on a top of an engine to form combustion chambers together with a plurality of engine cylinders, an intake manifold having a plurality of runners connected to a plurality of intake ports formed in the cylinder head so as to be in fluid communication with the plurality of engine cylinders through the plurality of intake ports and the plurality of runners, and a water cooling intercooler having an outlet connected to an inlet to the intake manifold for cooling at least one of EGR gas and new air with cooling water.

The structure may further include a high pressure EGR passage formed in the intake manifold for supplying high pressure EGR gas to an inlet to the plurality of runners.

At least one of the high pressure EGR gas, low pressure EGR gas, and the new air may be introduced through the inlet to the plurality of runners, and therefrom to the plurality of engine cylinders, having passed through the plurality of runners.

The structure may further include a flange connected between the intake manifold and the cylinder head.

The water cooling intercooler may be arranged on an upper side of the intake manifold in a vehicle height direction.

The plurality of runners may be formed parallel to a plane containing a vehicle width direction and a vehicle length direction, or in an acute angle from the plane.

The water cooling intercooler may include an inlet tank for introducing at least one of the low EGR gas and the new air, an outlet tank for discharging at least one of the low EGR gas and the new air to the intake manifold, and a core arranged between the inlet tank and the outlet tank for cooling at least one of the low EGR gas and the new air, in which an outlet of the outlet tank is configured to be connected to an inlet to the intake manifold.

The structure may further include, at an outlet side of the outlet tank, an empty space of a specific volume formed for moderating intake gas interference.

The inlet tank may include an air control valve mounted thereto for controlling a flow rate of at least one of the low pressure EGR gas and the new air being introduced to the water cooling type of intercooler.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates a perspective view of a related art structure of an engine system having a water cooling type of intercooler applied thereto.

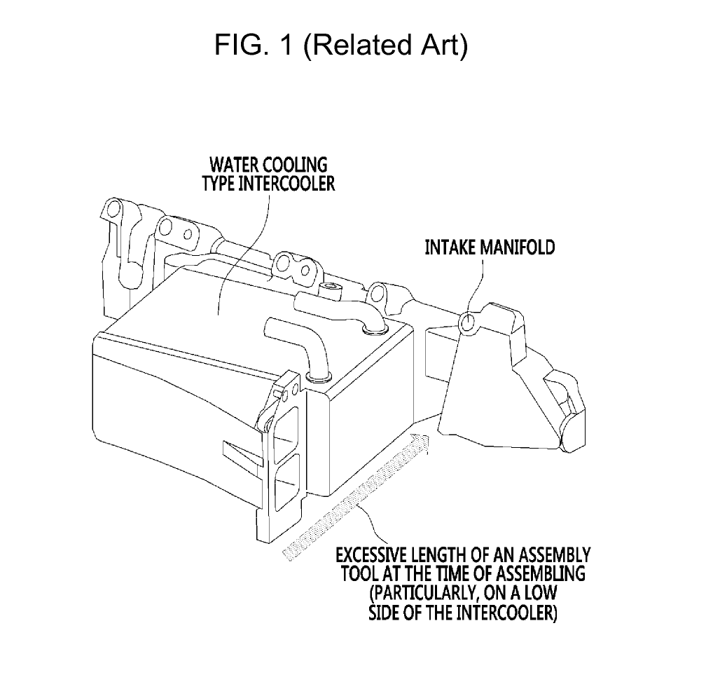

FIG. 2 illustrates a top plan view of a related art structure of an engine system having a water cooling type of intercooler applied thereto.

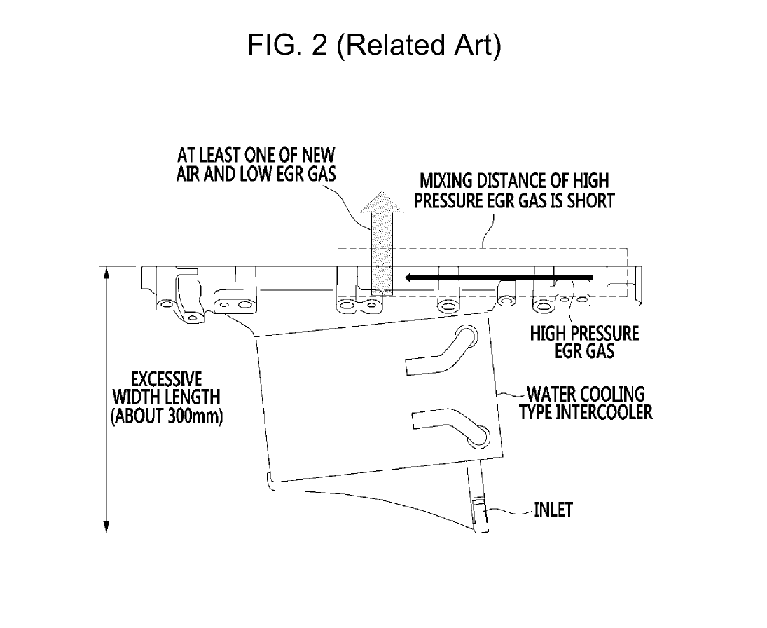

FIG. 3 illustrates a perspective view of an exemplary structure of an engine system according to the present invention.

FIG. 4 illustrates a front view of an exemplary structure of an engine system according to the present invention.

FIG. 5 illustrates a top plan view of an exemplary structure of an engine system according to the present invention.

FIG. 6 illustrates an exploded perspective view of an exemplary structure of an engine system according to the present invention, showing an operation principle thereof

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Moreover, a name of an element does not limit a function of the element. Exhaust gas recirculation (EGR) will be represented with EGR. An EGR system re-circulates exhaust gas for supplying the exhaust gas to a plurality of engine cylinders (not shown).

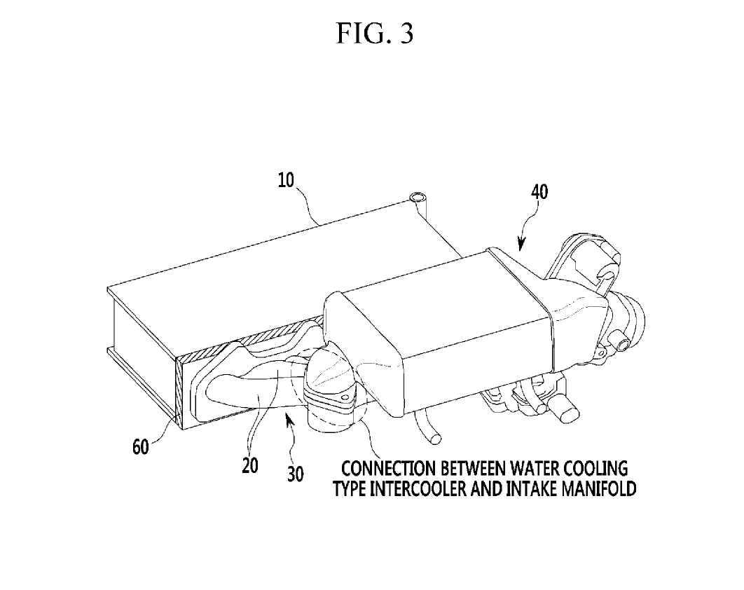

FIG. 3 illustrates a perspective view of a structure of an engine system in accordance with various embodiments of the present invention.

Referring to FIG. 3, the structure of an engine system may include a cylinder head 10 on a top of an engine to form combustion chambers together with a plurality of cylinders, an intake manifold 30 having a plurality of runners 20 connected to a plurality of intake ports (not shown) formed at the cylinder head 10 so as to be in fluid communication with the plurality of engine cylinders through the plurality of intake ports and the plurality of runners 20, and a water cooling type of intercooler 40 having an outlet connected to an inlet to the intake manifold for cooling at least one of EGR gas and new air with cooling water.

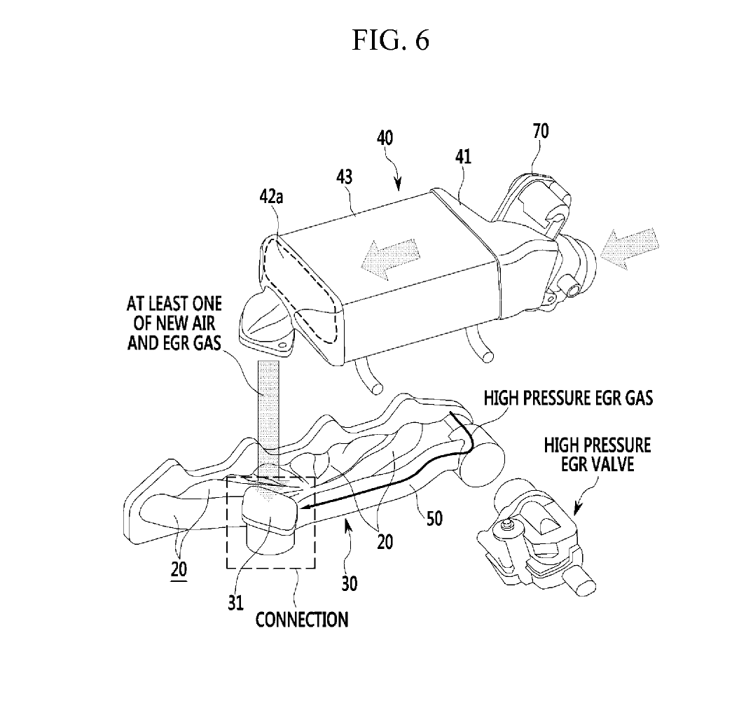

Since the plurality of intake ports are passages formed in the cylinder head so as to be in communication with the plurality of engine cylinders and are structures apparent to persons skilled in this field of art, detailed description and drawing thereof will be omitted. If an EGR system is applied to the structure in accordance with various embodiments of the present invention, a high pressure EGR passage 50 (see FIG. 6) may be formed in the intake manifold 30 for supplying the high pressure EGR gas to an inlet to the plurality of runners 20. With this, a separate EGR pipe for supplying the high pressure EGR gas may be removed. FIG. 3 illustrates a perspective view of a structure of an engine system in accordance with various embodiments of the present invention, if the EGR system is applied thereto.

At least one of the high pressure EGR gas, the low pressure EGR gas, and the new air is introduced through the inlet to the plurality of runners 20, and therefrom to the plurality of engine cylinders having passed through the plurality of runners 20. Therefore, as the mixed gas of the new air and the high pressure EGR gas, or the new air and the low pressure EGR gas and the high pressure EGR gas meet with one another and flows through the plurality of runners 20, the EGR distribution is improved. This is because of the plurality of runners 20 having an adequate length function as mixing spaces of the gases. Moreover, uniformity of the flow is also improved.

Referring to FIG. 3, the structure of an engine system in accordance with various embodiments of the present invention may further include a flange 60 connected between the intake manifold 30 and the cylinder head 10. As a variation, instead of the flange 60, a gasket may be mounted for tight sealing of the mixed gas.

In FIG. 3, connection between the water cooling type of intercooler 40 and the intake manifold 30 is shown with a dashed line. Since the water cooling type of intercooler 40 is arranged above the intake manifold 30 for the water cooling type of intercooler 40 to couple to the intake manifold 30 in a lower direction, it can be known that assembling and mounting of the water cooling type of intercooler 40 is improved in comparison to the related art.

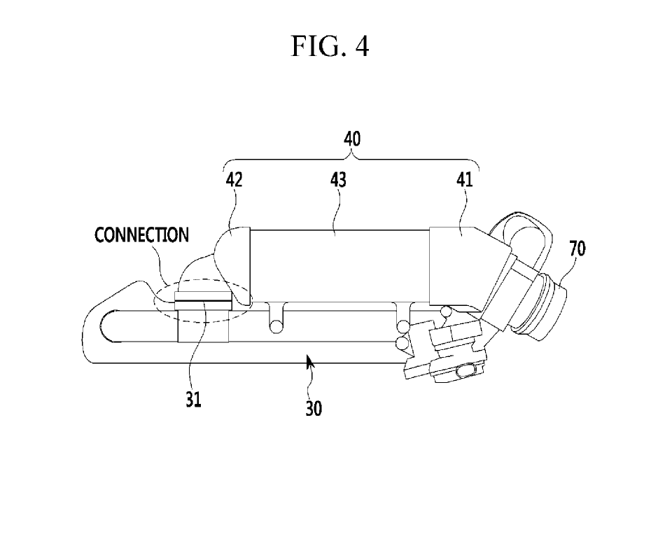

FIG. 4 illustrates a front view of a structure of an engine system in accordance with various embodiments of the present invention.

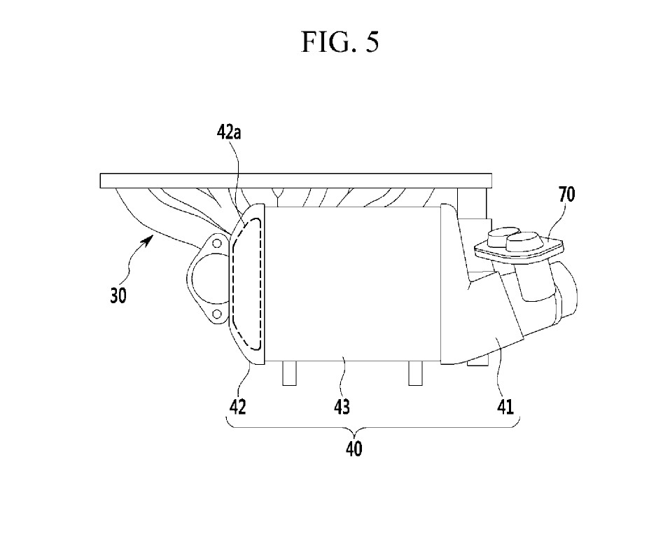

FIG. 5 illustrates a top plan view of a structure of an engine system in accordance with various embodiments of the present invention.

Referring to FIG. 4 and FIG. 5, the water cooling type of intercooler 40 may be arranged on an upper side of the intake manifold 30 in a vehicle height direction. With this, assembling and mounting of the structure of an engine system is improved compared to the related art.

The plurality of runners 20 may be formed parallel to a plane of a vehicle width direction and a vehicle length direction, or in an acute angle from the plane. This is for forming a space required for effectively mounting the water cooling type of intercooler 40 on the upper side of the intake manifold 30.

Referring to FIG. 4 and FIG. 5, the water cooling type of intercooler 40 may include an inlet tank 41 for introducing at least one of the low EGR gas and the new air, an outlet tank 42 for discharging at least one of the low EGR gas and the new air to the intake manifold 30, and a core 43 arranged between the inlet tank 41 and the outlet tank 42 for cooling at least one of the low EGR gas and the new air.

As shown in FIG. 4, an outlet of the outlet tank 42 is connected to an inlet 31 of the intake manifold 30.

Referring to FIG. 5, at an outlet side of the outlet tank 42, an empty space 42a of a specific volume may be formed for moderating the intake gas interference. This is shown with a dashed line in FIG. 5.

The intake gas interference is interference among waves of mixed gases at a gas meeting portion, making the intake efficiency to the engine poor. In order to prevent this from taking place, in general, a surge tank is mounted to or formed at the intake manifold.

If the empty space is formed in the outlet tank 42 appropriately according to the preferred embodiment of the present invention, the outlet tank 42 may function as the surge tank of the intake manifold.

Further, the inlet tank 41 may have an air control valve 70 mounted thereto for controlling a flow rate of at least one of the low pressure EGR gas and the new air being introduced to the water cooling type of intercooler 40. If no EGR system is applied, the air control valve 70 may control the flow rate of only the new air.

FIG. 6 illustrates an exploded perspective view of a structure of an engine system in accordance with various embodiments of the present invention, showing an operation principle thereof. Referring to FIG. 6, the new air which is compressed external air or a mixed gas of the new air and the low pressure EGR gas has the flow rate controlled by the air control valve 70 and is introduced to the water cooling type of intercooler 40. FIG. 6 illustrates an exploded perspective view of a structure of an engine system in accordance with a preferred embodiment of the present invention, having an EGR system applied thereto. Thus, the air control valve 70 controls the flow rate of the mixed gas of the new air and the low pressure EGR gas.

The gas cooled as it passes through the core 43 of the water cooling type of intercooler has the intake gas interference suppressed to have a uniform flow as the gas passes through the empty space 42a of the outlet tank 42 which functions as the surge tank.

If the EGR system is applied, at least one of the new air and the low pressure EGR gas may meet the high pressure EGR gas being supplied thereto through a high pressure EGR passage 50 as at least one of the new air and the low pressure EGR gas is introduced through the inlet 31 of the intake manifold 30.

As described before, the new air or the mixed gas of the new air and the low pressure EGR gas is mixed as the new air or the mixed gas of the new air and the low pressure EGR gas passes through the plurality of runners 20 having adequate length together with the high pressure EGR gas. Eventually, mixing and flowing of the gases becomes uniform. At the end, the EGR distribution of the new air and the EGR gas being supplied to the plurality of engine cylinders is improved. Thus, the structure of an engine system in accordance with the present invention permits improvement of mounting and assembling of the water cooling type of intercooler and the EGR distribution, if the EGR system is applied thereto, and secures rigidity of an assembled structure. Along with this, if a specification of the intercooler is changed with an identical engine, the change of the intercooler may be dealt with through an identical intake manifold.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A structure of an engine system, comprising:
a cylinder head on a top of an engine so as to form combustion chambers together with a plurality of engine cylinders;
an intake manifold having a plurality of runners connected to a plurality of intake ports formed in the cylinder head to be in fluid communication with the plurality of engine cylinders through the plurality of intake ports and the plurality of runners; and
a water cooling intercooler having an outlet connected to an inlet of the intake manifold for cooling at least one of Exhaust Gas Recirculation (EGR) gas and new air with cooling water.

2. The structure of claim 1, further comprising:
a high pressure EGR passage formed in the intake manifold for supplying high pressure EGR gas to an inlet of the plurality of runners.

3. The structure of claim 1, wherein at least one of the high pressure EGR gas, low pressure EGR gas, and the new air is introduced through the inlet to the plurality of runners, and therefrom to the plurality of engine cylinders, having passed through the plurality of runners.

4. The structure of claim 1, further comprising:
a flange connected between the intake manifold and the cylinder head.

5. The structure of claim 1, wherein the water cooling intercooler is arranged on an upper side of the intake manifold in a vehicle height direction.

6. The structure of claim 5, wherein the plurality of runners are formed parallel to a plane in a vehicle width direction and the vehicle length direction, or in an acute angle from the plane.

7. The structure of claim 5, wherein the water cooling intercooler includes:
an inlet tank for introducing at least one of the low EGR gas and the new air;
an outlet tank for discharging at least one of the low EGR gas and the new air to the intake manifold; and
a core arranged between the inlet tank and the outlet tank for cooling at least one of the low EGR gas and the new air,
wherein an outlet of the outlet tank is configured to be connected to the inlet of the intake manifold.

8. The structure of claim 7, further comprising, at an outlet side of the outlet tank, an empty space of a volume formed for moderating intake gas interference.

9. The structure of claim 7, wherein the inlet tank includes an air control valve mounted thereto for controlling a flow rate of at least one of the low pressure EGR gas and the new air being introduced to the water cooling type of intercooler.
